(19) United States
(12) Patent Application Publication
(10) Pub. No.: US 2023/0039684 A1
(43) Pub. Date: Feb. 9, 2023

(54) SYSTEMS AND METHODS FOR CREATING SHARABLE MEDIA ALBUMS

(71) Applicant: META PLATFORMS TECHNOLOGIES, LLC, Menlo Park, WA (US)

(72) Inventors: Joshuah Vincent, Seattle, WA (US); Ruchir Srivastava, Sunnyvale, CA (US); Leon Zhan, Mountain View, WA (US)

(21) Appl. No.: 17/393,284

(22) Filed: Aug. 3, 2021

(51) Int. Cl. G06F 16/45; G06F 16/44; G06F 16/41; G06N 20/00

(52) U.S. Cl. CPC G06F 16/45; G06F 16/44; G06F 16/41; G06N 20/00

(57) ABSTRACT

The disclosed computer-implemented method may include (i) detecting a collection of media files captured by a wearable media device, (ii) determining a selection of the media files representing a common set of user experiences accumulated over a continuous period, (iii) grouping the selection of the media files into a customizable container, and (iv) sharing the customizable container with one or more target recipients for viewing within a secure application portal. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for creating sharable media albums.

FIG. 2 is a block diagram of an exemplary system for creating sharable media albums.

FIG. 3 is a block diagram of an additional exemplary system for creating sharable media albums.

FIG. 4 is an illustration of exemplary computing device display screens generated by a client application for creating sharable media albums.

FIG. 5 is an illustration of additional exemplary computing device display screens generated by a client application for creating sharable media albums.

FIG. 6 is an illustration of an additional exemplary computing device display screen generated by a client application for creating sharable media albums.

FIG. 7 is an illustration of additional exemplary computing device display screens generated by a client application for creating sharable media albums.

FIG. 8 is an illustration of an exemplary computing device display screen generated by a client application for sharing a created media album.

FIG. 9 is an illustration of additional exemplary computing device display screens generated by a client application for sharing a created media album.

FIG. 10 is an illustration of additional exemplary computing device display screens generated by a client application for sharing a created media album.

FIG. 11 is an illustration of additional exemplary computing device display screens generated by a client application for sharing a created media album.

FIG. 12 is an illustration of exemplary augmented-reality glasses that may be used in connection with embodiments of this disclosure.

FIG. 13 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Wearable computing devices such as smart watches and smart glasses, which may contain virtual reality (VR) systems and augmented reality (AR) systems (collectively known as wearable artificial reality systems), typically include the capability of capturing media (e.g., photos and videos) in real-time for storage with a cloud storage service provider. Often, this captured media may include a massive and/or unorganized collection of files typically stored in media galleries or libraries for later retrieval and/or viewing by a user via an associated application on one or more user computing devices.

Unfortunately, conventional applications associated with wearable computing devices may often require users to engage in a time-consuming process involving perusing through hundreds of files as new media is added to a library to identify and organize common themes or memories (e.g., social experiences) a user may wish to access. For example, wearable artificial reality systems may be capable of generating enormous amounts of content through the continuous and/or simultaneous (e.g., by utilizing systems operating in conjunction with one another) capture of images, video, audio, localization data, three-dimensional data, etc., while also only providing limited input and organization capabilities as they lack touchscreens or other appropriate input methods for managing captured content. As a result, identifying content that may be relevant to a user for personal viewing and/or sharing with others is often a challenge on wearable AR systems. Additionally, these conventional applications often fail to provide privacy options for users that would like to selectively share social experiences captured in their media collections with a limited audience.

The present disclosure provides systems and methods for (1) detecting a collection of media files captured by a wearable computing or media device (such as a wearable artificial reality system), (2) determining a selection of the media files (e.g., images and videos) representing a common set of user experiences accumulated over a continuous period, (3) grouping the selection of the media files into a customizable container (e.g., a media album); and (4) sharing the media album with one or more target recipients for viewing within a secure application portal. In some examples, the media files may represent content that is continually captured by a single wearable media device, multiple wearable media devices, or a wearable media device operating in combination with another media capture device (e.g., a smartphone) utilizing multiple cameras to capture different perspectives of the same event. In some examples, the media files may be grouped in user-generated manual albums based on selected media or in user-generated “smart” albums based on user-selected classifiers utilized to populate a container with media corresponding to the classifiers. In these examples, each classifier may describe one or more common features in captured content represented in the media files. Additionally or alternatively, the media files may be grouped in artificial intelligence (AI) generated albums based on media captured over a continuity in time and having semantic similarity so as to represent a complete experience captured by a user of the wearable media device. In these examples, a machine-learning algorithm may analyze the media files to detect classifiers describing one or more common features in captured content and then identify a set of the media files as the selection for the AI generated album based on the classifiers.

The disclosed systems and methods may group the selection of the media files by (1) storing the selection of media files as a content album in the customizable container and adding metadata describing the content album. In some examples, the metadata may include an album title, an album descriptor, a narrative descriptor, an album creation date and time, an album creator identification, an album location, and/or a time and date range of captured media in the content album. In some examples, new media files may be added to an existing album by (1) detecting the addition of the new media files to the collection of media files, analyzing the new media files for the common set of user experiences (e.g., classifiers and/or continuity in time and semantic similarity) and (2) adding the new media files containing the common set of user experiences to the album.

The disclosed systems and methods may share media albums by adding each of a group of selected target recipients as a viewer of stored media within a client application associated with the wearable media device. In some examples, a shared media album may be automatically updated as new media is captured and added to the shared media album. In some examples, the client application may generate a notification including a link for target recipients to access the media from a shared media album within a family of social networking applications or platforms.

The present disclosure provides a system that allows users to organize and access captured media (e.g., pictures and videos captured by AR wearable devices) from their collections and to share their media with friends or family in a private setting. By enabling the creation of smart albums that group captured collected media based on user-selected classifiers and/or semantic similarities over a continuous period, the present disclosure may provide a more complete experience of user memories represented by the collected media for privately sharing as a narrative with designated viewers (e.g., friends and family) in a safe and secure manner over a variety of messaging applications and/or platforms. Moreover, the present disclosure may provide for the filtering of media captured in multiple simultaneous feeds (e.g., video feeds) or by multiple cameras on a single device. Thus, the present disclosure offers a number of advantages over conventional techniques where media sharing from wearable media devices is limited with respect to input and organization capabilities for managing captured content resulting in the time-consuming process of manually identifying and organizing social experiences in a non-private setting.

The present disclosure may further improve the functioning of a computer itself by reducing the time needed to group a subset of data (e.g., a collection of media files) into a container from a larger dataset. The present disclosure may additionally improve the technical field of data privacy by enabling the sharing of a user's private data with designated recipients over one or more public media sharing applications and/or platforms.

Features from any of the embodiments described herein may be used in combination with one another in accordance with the general principles described herein. These and other embodiments, features, and advantages will be more fully understood upon reading the following detailed description in conjunction with the accompanying drawings and claims.

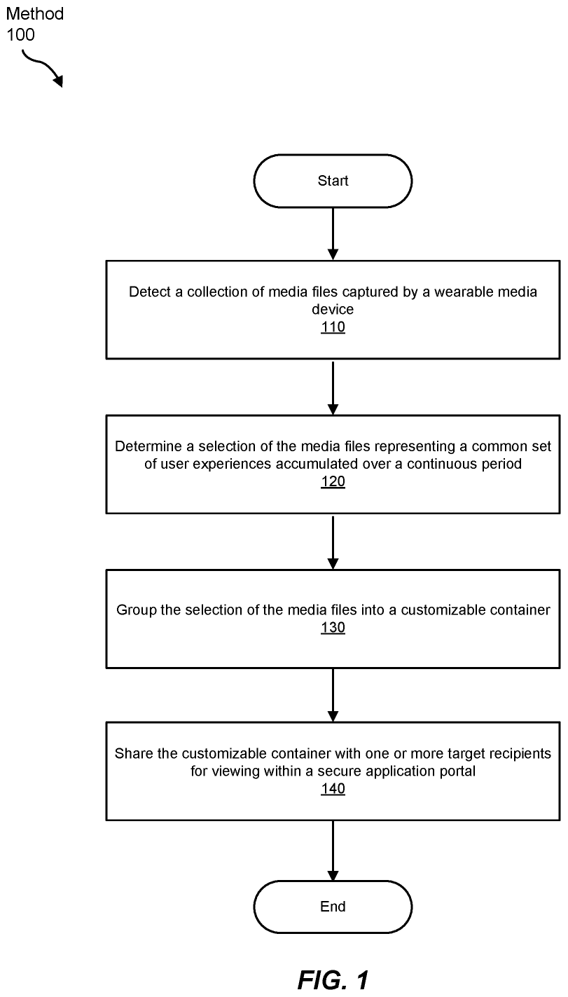

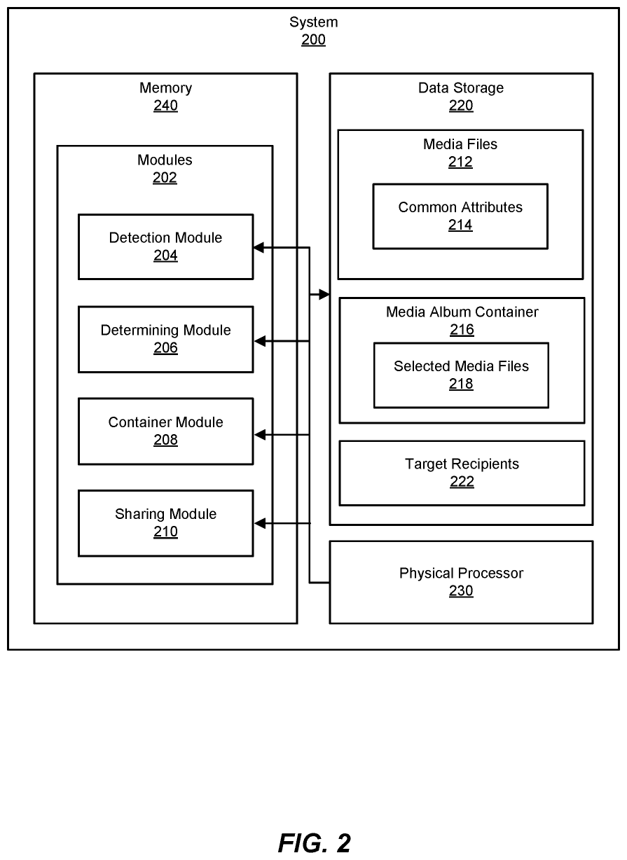

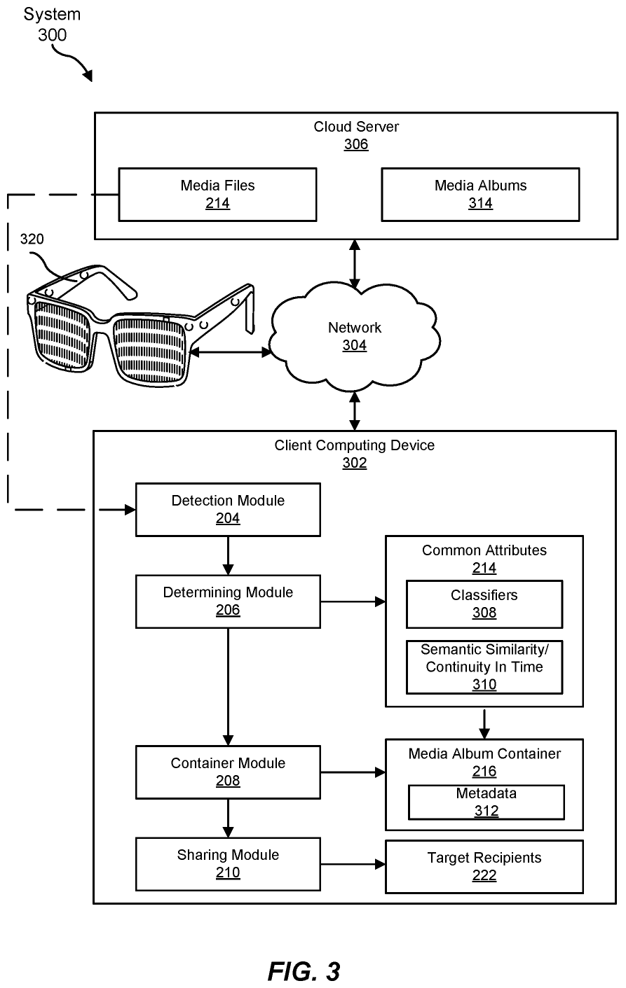

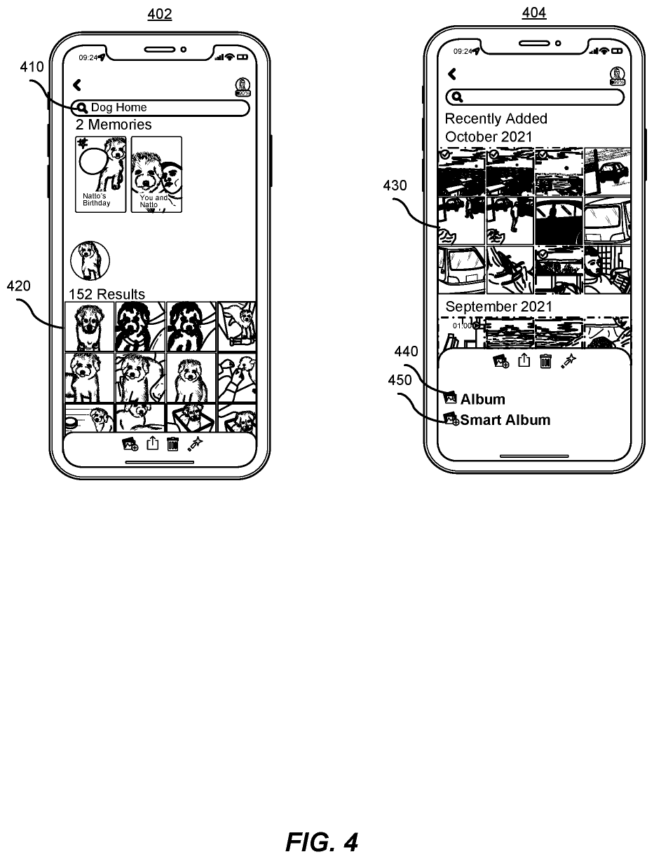

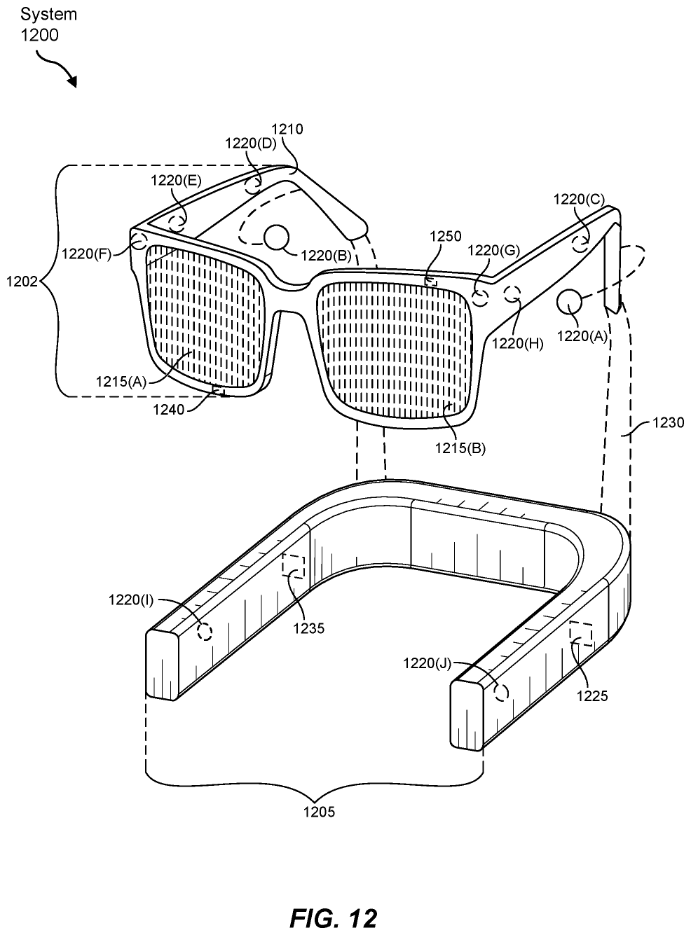

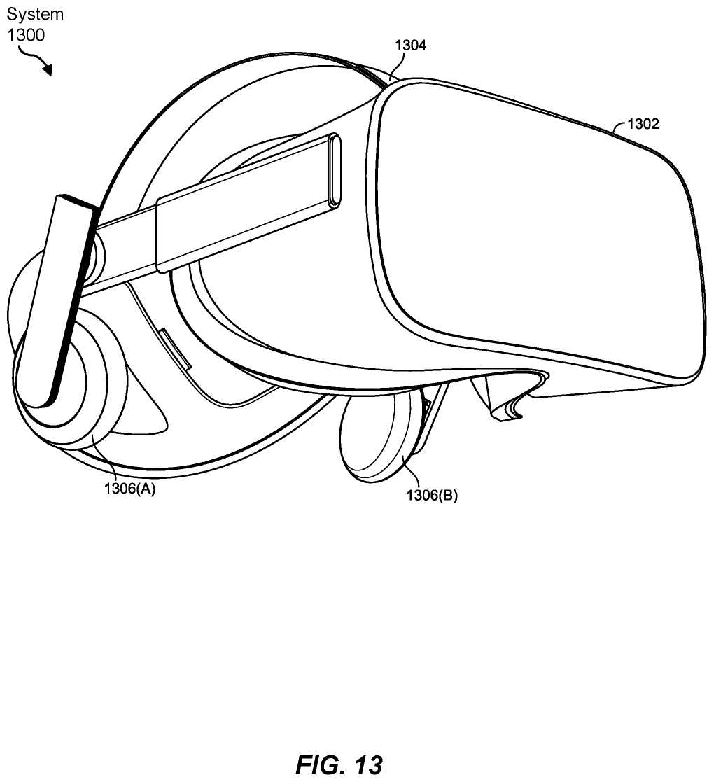

The following will provide, with reference to FIG. 1, detailed descriptions of computer-implemented methods for creating shareable media albums. Detailed descriptions of corresponding example systems will also be provided in connection with FIGS. 2-3. Additionally, detailed descriptions of corresponding computing device screen displays will be provided in connection with FIGS. 4-11. Finally, detailed descriptions of corresponding augmented and virtual reality systems-reality glasses will be provided in connection with FIGS. 12-13.

FIG. 1 is a flow diagram of an exemplary computer-implemented method 100 for creating sharable media albums. The steps shown in FIG. 1 may be performed by any suitable computer-executable code and/or computing system, including the system illustrated in FIGS. 2-3. In one example, each of the steps shown in FIG. 1 may represent an algorithm whose structure includes and/or is represented by multiple sub-steps. In one embodiment, the steps shown in FIG. 1 may be performed by modules stored in a memory of a computing system and/or operating within a computing device. For example, the steps shown in FIG. 1 may be performed by modules 202 stored in a memory 240 of a computing system further including a data storage 220 and a physical processor 230 (e.g., as shown in exemplary system 200 in FIG. 2) and/or modules operating in a client computing device 302 (e.g., as shown in exemplary system 300 in FIG. 3) and/or modules operating in a cloud server 306.

Data storage 220 generally represents any type or form of machine-readable medium capable of storing information. In one example, data storage 220 may include media files captured by a wearable media device 320, a media album container, and data identifying target recipients utilized in creating shareable media albums.

Client computing device 302 generally represents any type or form of computing device capable of reading computer-executable instructions. For example, client computing device 302 may represent a smart phone and/or a tablet. Additional examples of client computing device 302 may include, without limitation, a laptop, a desktop, a wearable device, a personal digital assistant (PDA), etc. In some examples (and as will be described in greater detail below), client computing device 302 may be utilized to create media albums 314 from media files captured by wearable media device 320 and stored on cloud server 306.

Wearable media device 320 generally represents any type or form of computing device capable of reading computer-executable instructions. In some example, wearable media device 320 may represent a pair of smart glasses, a smartwatch, a head-mounted virtual reality display, etc., configured to capture images and video as media files 212 for either local or cloud storage (e.g., storage on cloud server 306).

Cloud server 306 generally represents any type or form of backend computing device that may perform one or more functions directed at providing on-demand computer system resources such as, for example, data storage without direct active management by a user. In some examples, cloud server 306 may include one or more data centers for storing user data captured and/or created by client computing device 302 and wearable media device 320, such as media files 212 and media albums 314. Although illustrated as a single entity in FIG. 3, cloud server 306 may include and/or represent a group of multiple servers that operate in conjunction with one another.

Network 304 generally represents any medium or architecture capable of facilitating communication or data transfer. In one example, network 304 may facilitate communication between client computing device 302, cloud server 306, and wearable media device 320. In this example, network 304 may facilitate communication or data transfer using wireless and/or wired connections. Examples of network 304 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network.

Returning to FIG. 1, at step 110, one or more of the systems described herein may detect a collection of media files captured by a wearable media device. For example, as illustrated in FIGS. 2-3, a detection module 204 may detect media files 212 (e.g., image and/or video files) captured by wearable media device 320 and stored on cloud server 306 (or optionally, stored on wearable media device 320).

Detection module 204 may detect media files 212 in a variety of ways. In some embodiments, detection module 204 may be a component of a media viewing and sharing application configured to access and identify media files 212 saved to cloud server 306 after they have been captured from wearable media device 320. In these embodiments, media files 212 may represent content that is continually captured by wearable media device 320 utilizing multiple cameras to capture different perspectives of the same event. Additionally or alternatively, detection module 204 may access and identify media files 212 directly from wearable media device 320 (where they may locally stored). In some embodiments, detection module 204 may be configured to access new instances of media files 212 as they are being captured (or immediately following capture) by wearable media device 320.

Returning to FIG. 1, at step 120, one or more of the systems described herein may determine a selection of the media files captured by the wearable media device. For example, as illustrated in FIGS. 2-3, determining module 206 may determine selected media files 218 captured by wearable media device 320. In some examples (and as will be described in greater detail below), determining module 206 may be configured to allow a manual selection of captured media (e.g., images and/or videos) from media files 212 by a user and/or utilize AI to automatically select captured media from media files 212 as an initial step in creating a media album 314.

Determining module 206 may determine selected media files 218 in a variety of ways. In some examples, determining module 206 may enable a manual selection of captured media by in response to capture media that is handpicked by a user from media files 212. Additionally or alternatively, determining module 206 may enable a manual selection of captured media by generating, in response to a user selection, one or more classifiers 308 describing common attributes 214 (e.g., a user's pet dog) represented in media files 212 and then identifying a set of the media files 212 as selected media files 218 based on classifiers 308. In this example, a media album (e.g., a media album 314) that is created from selected media files 218 based on classifiers 308 may be identified as “smart albums” since a user does not need to handpick the content for populating this type of media album.

In these examples, determining module 206 may be configured to provide a user interface allowing a user to manually initiate a query based on one or more search terms describing captured media in media files 212. Furthermore, in some examples, determining module 206 may be configured to analyze, utilizing AI (i.e., a machine learning algorithm), media files 212 to detect metadata (e.g., metadata 312) describing one or more common features in captured content and identifying a set of the media files 212 as selected media files 218 based on metadata 312. In some examples, determining module 206 may utilize an AI-generated classifier model configured to understand content contained in media files 212 for generating classifiers 308.

For example, FIG. 4 shows exemplary computing device display screens 402 and 404 (i.e., screens 402 and 404) generated by a media viewing and sharing application initiated by determining module 206. As shown in FIG. 4, screen 402 shows a query interface 410 including search terms (i.e., “Dog” and “Home”) representing a manual query submitted by a user and returning query results 420 from which a user may manually select images for creating an album (e.g., a media album 314). Screen 404 shows results 430 from a user for recently added media files 212 from which a user may manually select images for creating an album (e.g., a media album 314) via option 440 or 450 (these options may also be available on screen 402).

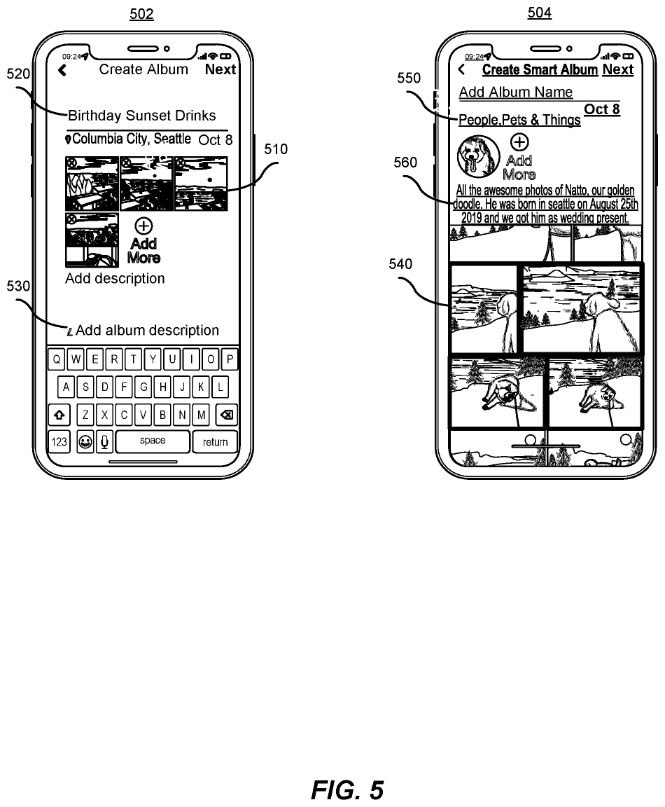

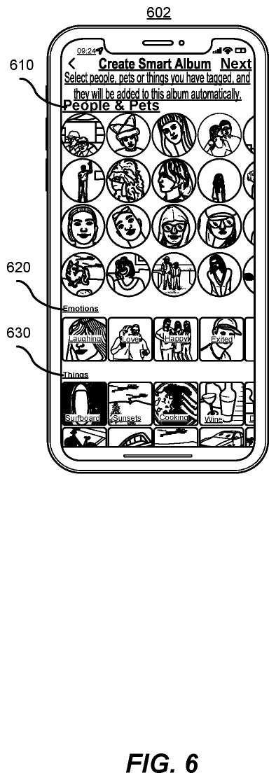

As another example, FIG. 5 shows exemplary computing device display screens 502 and 504 (i.e., screens 502 and 504) generated by a media viewing and sharing application initiated by determining module 206. As shown in FIG. 5, screen 502 shows an example of an AI generated selection of media grouped by semantic similarity/continuity in time 310. In this example, determining module 206 may utilize a machine learning algorithm to search media files 212 for media 510 having similar descriptions (e.g., “Birthday” and “Drinks”) captured by wearable media device 320 over a continuous period of time (e.g., the evening of October 8^{th}) as an initial step of creating a media album 314. Screen 504 shows an example of a classifier 550 (i.e., “People, Pets & Things”) that may be selected by a user to display media 540 representing the dog “Natto.” As another example, FIG. 5 shows exemplary computing device display screens 502 and 504 (i.e., screens 502 and 504) generated by a media viewing and sharing application initiated by determining module 206. As shown in FIG. 5, screen 502 shows an example of an AI generated selection of media grouped by continuity in time and semantic similarity. In this example, determining module 206 may utilize a machine learning algorithm to search media files 212 for media 510 having similar descriptions (e.g., “Birthday” and “Drinks”) that was captured by wearable media device 320 over a continuous period of time (e.g., the evening of October 8^{th}) as an initial step of creating a media album 314. Screen 504 shows an example of a classifier 550 (i.e., “People, Pets & Things”) that may be selected by a user to display media 540 representing the dog “Natto.” As yet another example, FIG. 6 shows an exemplary computing device display screen 602 (i.e., screens 602) generated by a media viewing and sharing application initiated by determining module 206. As shown in FIG. 6, screen 604 shows example classifiers 610 (i.e., “People & Pets”), 620 (i.e., “Emotions”) and 630 (i.e., “Things”) that may be selected by a user to display captured media for inclusion in a created media album 314.

Returning to FIG. 1, at step 130, one or more of the systems described herein may group the selection of the media files into a customizable container. For example, as illustrated in FIGS. 2-3, container module 208 may group selected media files 218 into media album container 216.

Container module 208 may group selected media files 218 in a variety of ways. In some examples, container module 208 may store selected media files 218 as a content album in media album container 216 and add metadata 312 describing the content album. In some embodiments, metadata 312 may include, without limitation, an album title, an album descriptor (e.g., user added text describing a media album 314), a narrative descriptor (e.g., inline descriptive text or location information to facilitate the telling of a story), an album creation date and time, an album creator identification (e.g., the ID of a user of client computing device 302 and/or wearable media device 320), an album location (e.g., a geographical location or locations associated with images and/or videos in media album 314), and/or a time and date range of captured media in the content album. In some examples, the album title, album descriptor, and narrative description in metadata 312 for a media album 314 may be added by a user. For example, screen 502 in FIG. 5 shows an album title 520 and a field for adding an album descriptor 530 for media 510. As another example, screen 504 in FIG. 5 shows a narrative description 560 for media 540. Additionally, the album creation date and time, album creator identification, album location, and the time and date range of captured media in metadata 312 may be automatically added by container module 208 (e.g., metadata 312 may be inherited from previously embedded top-level metadata such as “people,” “location,” “activity,” and “weather,” associated with selected media files 218). In some examples, the album title and album descriptor in metadata 312 may be edited by a user after creation of a media album 314 and may not necessarily be unique (e.g., multiple media albums 314 may have the same album title).

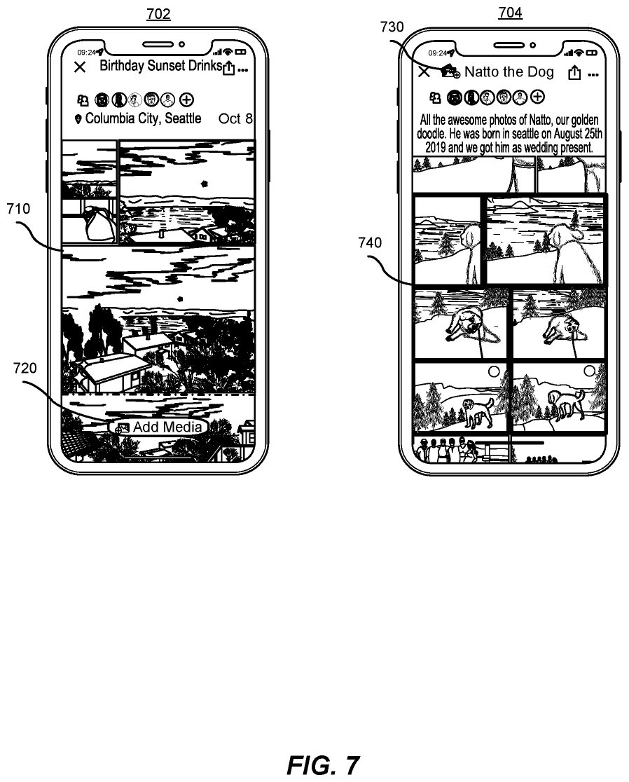

In some examples, container module 208 may be configured to allow for additional editing and/or customization actions by a user including, without limitation, deletion of a media album 314 (i.e., deletion of media album container 216 without deletion of any media content contained therein), setting an album cover (e.g., the user may select an image to serve as an album cover for a media album 314), creating a narrative compilation (e.g., creating one or more compilations of the highest ranked media in a media album 314), removing content (i.e., removing media content without deletion), ordering content (e.g., a user may drag content to order it within a media album 314 where a default order may be date/time, newest to oldest), making a media album 314 searchable among multiple media albums 314 (e.g., search results may include manually added albums or “smart” albums based on classifiers 308), making a media album 314 browsable from a media gallery, and creating manual albums from content within a given media album 314 that has previously been created. In some examples, container module 208 may further be configured to detect the addition of new media files (e.g., new media files added by a user to wearable media device 320 and/or cloud server 306), analyze the new media files for a common set of user experiences, and add the new media files containing the common set of user experiences to media album container 216. For example, FIG. 7 shows an exemplary computing device display screen 702 (i.e., screen 702) including media album content 710 associated with the album entitled “Birthday Sunset Drinks.” Screen 702 also includes an option 720 for a user to add new media content to the previously created album. FIG. 7 further shows an exemplary computing device display screen 704 (i.e., screen 704) including media album content 740 associated with the smart album entitled “Natto the Dog.” In this example, screen 704 may display a smart album icon 730 so as to notify a viewer that media album content 740 is associated with one or more classifiers 308 (e.g., a “People & Pets” classifier).

Returning to FIG. 1, at step 140, one or more of the systems described herein may share the customizable container with one or more target recipients for viewing within a secure application portal. For example, as illustrated in FIGS. 2-3, sharing module 210 may share media album container 216 with one or more target recipients 222 as a media album 314 for viewing within any of a variety of applications including a family of social networking applications or platforms.

Sharing module 210 may share media album container 216 with target recipients 222 as a media album 314 in a variety of ways. In some examples, sharing module 210 may provide an interface for a user (e.g., a media album creator or contributor) to add target recipients 222 as viewers of selected media files 218 contained in a media album 314. Additionally or alternatively, sharing module 210 may be configured to share newly captured media files with target recipients 222 as they are being added to a media album 314 as the captured new media files are added to a customizable container (e.g., media album container 216) for a previously created media album 314. In some examples sharing module 210 may additionally generate a notification including an access link for accessing a media album 314 for access by target recipients 222. In these examples, the access link may point to one or more of a social networking application or messaging platform accessible by target recipients 222.

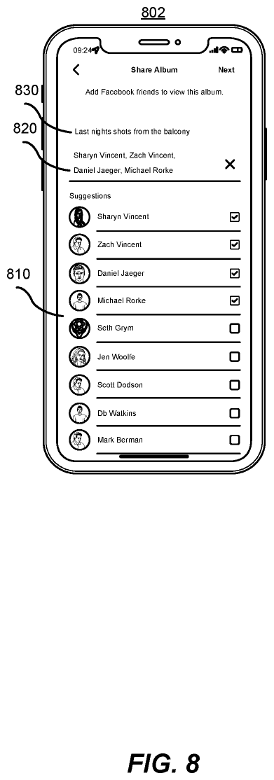

For example, FIG. 8 shows an exemplary computing device display screen 802 (i.e., screen 802) providing a user interface for selecting target recipients 820 from among a list of contacts 810 associated with a user sharing a media album 314. In some embodiments, the user interface provided on screen 802 may further include an album notification message 830 including a brief description of a shared media album 314.

In some examples, a shared media album 314 may be shared to any number of networking and or messaging applications/platforms via a media viewing and sharing application utilized by a user to create, modify, and/or edit media albums 314 as discussed above in the description of FIG. 1. In some examples, media album 314 may be configured to be dynamic such that as new media files are added (e.g., manually or automatically based on classifiers 308), each of selected target recipients 820 may able to view the added new media files.

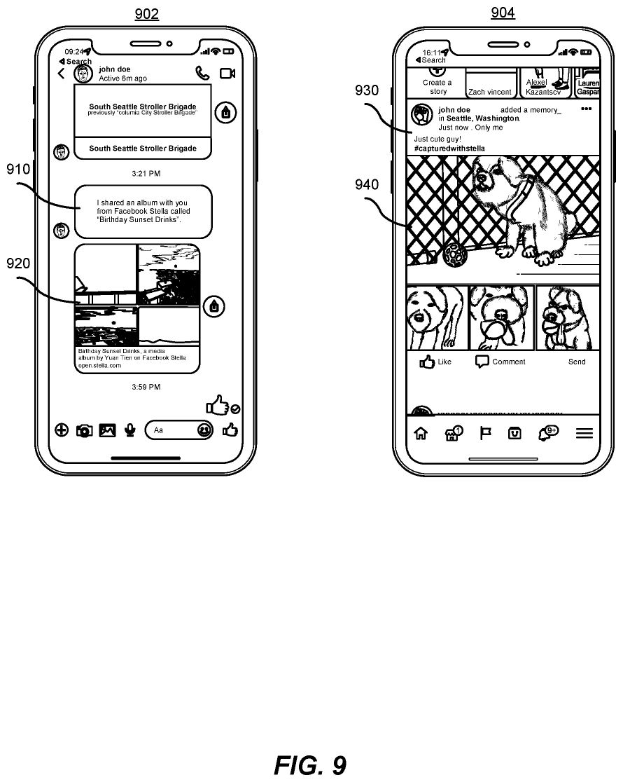

As another example, FIG. 9 shows exemplary computing device display screens 902 and 904 (i.e., screens 902 and 904) on which a media album messaging notification is displayed to target recipients 222 within a social networking messaging application platform. In this example, screen 902 displays a notification 910 of a shared media album 314 within a message feed. Screen 902 also displays a media album snippet 920 that includes a portion of shared media content as well as a link to view the entire media album 314 for viewing by a target recipient 222. In some examples, the link may point to a media viewing and sharing application utilized to create media album 314. Additionally or alternatively, the link may point to an album viewer component within the social networking messaging application platform. Continuing with this example, screen 904 displays a notification 930 posted by a user sharing selected images 940 from a media album 314 over a social networking feed.

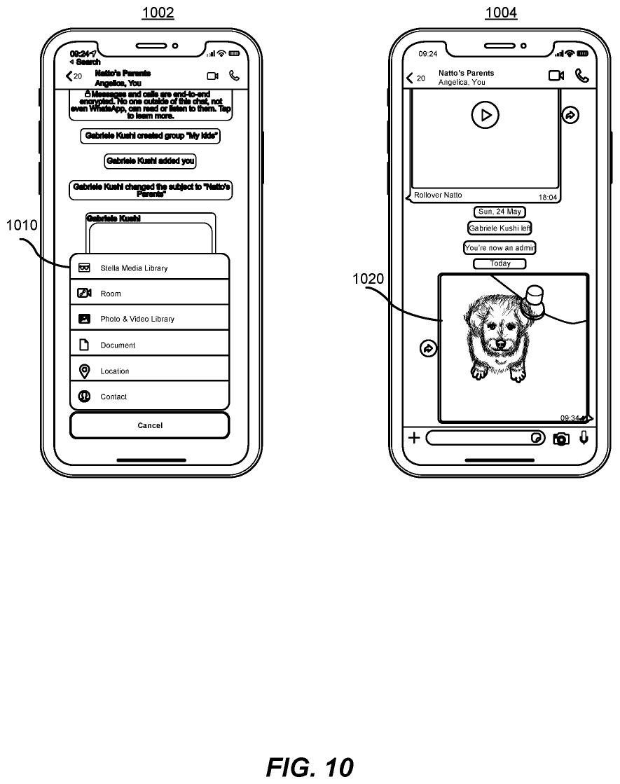

As yet another example, FIG. 10 shows exemplary computing device display screens 1002 and 1004 (i.e., screens 1002 and 1004) providing a user interface menu 1010 for sharing media content 1020 from a media album 314 in a messaging session within a centralized messaging and communications service platform. In this example, a user may select (as shown on screen 1002), from user interface menu 1010, an option to share content from a media album 314 during the messaging session, browse and or search through media album 314 to select media content 1020, and then post (as shown on screen 1004) media content 1020 for sharing during the messaging session.

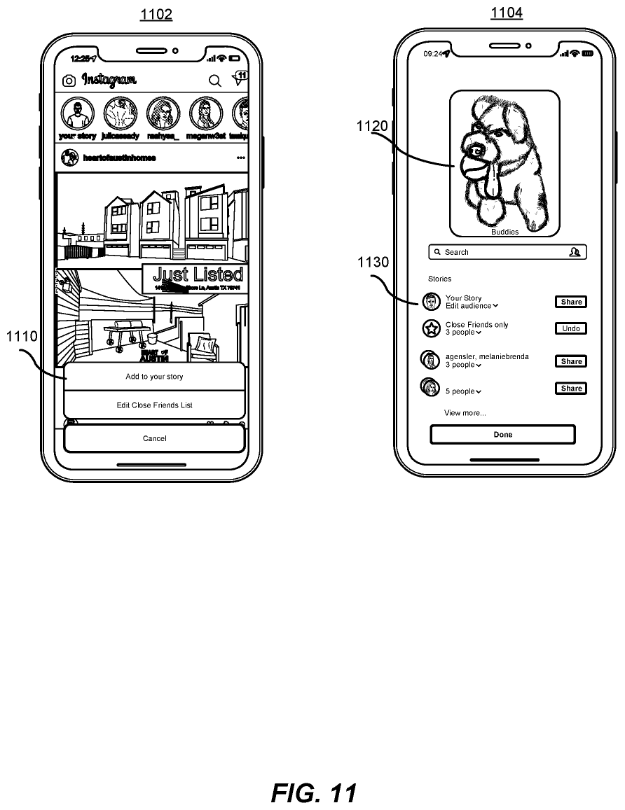

As yet another example, FIG. 11 shows exemplary computing device display screens 1102 and 1104 (i.e., screens 1102 and 1104) providing a user interface menu 1110 for sharing media content 1120 from a media album 314 in a narrative news feed session (e.g., a news feed for sharing short user-generated photo or video collections) on a social media network platform. In this example a user may select (as shown on screen 1102), from user interface menu 1110, an option to add content from a media album 314 to a current user narrative news feed session, browse and or search through media album 314 to select media content 1120, and then select, from a list of target recipients 1130, one or more parties with whom to share media content 1120 (a shown on screen 1104).

As explained in connection with method 100 above, the systems and methods described herein provide for a smart system allowing users to organize and access captured media (e.g., pictures and videos captured by AR wearable devices) from their collections and to share their media with friends or family in a private setting. The system includes artificial intelligence (AI) generated albums and user generated smart albums.

The AI generated album media is selected by an AI algorithm that uses continuity in time and semantic similarity to group media. The user generated smart album is populated by grouping media that contains classifiers selected by the user. As defined herein, classifiers may include information produced post capture by running media (e.g., an image) through an AI-generated classifier model that is capable of understanding content contained in for generating the classifiers. Furthermore, as defined herein, metadata may include information generated during the media capture process (e.g., date, location image type, et.). In some examples, metadata for an album may be added by a user (e.g., album title and album description) or by the system (e.g., date, time of creation, creator ID, and location). The system may further allow users to delete an album from their gallery or to remove content from an album. If a shared album is deleted, the system removes users from accessing the album and album media. The system may further allow users to select which media to use for the album cover. The system may further allow users to drag/move content within an album to organize it. The system may further allow users to locate an album within their gallery via browsing or searching and may manually create an album by selecting any content within a given album.

The system may further allow users to add one or more classifiers for creating groupings of content for smart album creation and to determine whether all classifiers must be present in a media item to be added. The system may further utilize face clustering to avoid tying specific faces to names and overcomes privacy challenges for smart albums containing pictures of people. As content is added to a user's collection and is analyzed to add classifiers, the system may further enable the content to be added to related smart albums.

The system may further group AI-generated album content is grouped based on time of capture, location, people, and visual similarity. The system may further link AI-generated albums across shared contexts to package longer experiences (e.g., day trips and nights out during a trip). The system may further automatically generate titles for AI-generated albums using top-level metadata from all media (e.g., people, location, activity, weather, etc.). The system may further provide album thumbnails for AI-generated albums. The system may further allow users to share their smart albums with a targeted set of viewers/contributors who can see the updated content as content is added to an album (e.g., manually or automatically).

The system may further provide controlled access to content to give the owner control over the privacy of their content. The system may further restrict the adding and or removal of specifically identified individuals (e.g., friends and/or family) as viewers. The system may further generate a notification of an album being shared via a messenger application with links back into the system to view the shared content. The system may further enable viewers to access shared albums and share the content in their own messaging applications.

### Example Embodiments

Example 1: A computer-implemented method comprising: detecting, by one or more computing devices, a collection of media files captured by a wearable media device; determining, by the one or more computing devices, a selection of the media files representing a common set of user experiences accumulated over a continuous period; grouping, by the one or more computing devices, the selection of the media files into a customizable container; and sharing, by the one or more computing devices, the customizable container with one or more target recipients for viewing within a secure application portal.

Example 2: The computer-implemented method of example 1, wherein detecting the collection of media files comprises detecting content continually captured by the wearable media device.

Example 3: The computer-implemented method of example 1 or 2, wherein determining the selection of the media files comprises: generating at least one classifier describing one or common features in captured content represented in the media files; and identifying a set of the media files as the selection based on the classifier.

Example 4: The computer-implemented method of any of examples 1-3, wherein determining the selection of the media files comprises: analyzing, utilizing a machine learning algorithm, the media files to detect metadata describing one or more common features in captured content; and identifying a set of the media files as the selection based on the metadata.

Example 5: The computer-implemented method of any of examples 1-4, wherein grouping the selection of the media files comprises: storing the selection of media files as a content album in the customizable container; and adding metadata describing the content album.

Example 6: The computer-implemented method of any of examples 1-5, wherein adding metadata describing the content album comprises adding at least one of: an album title; an album descriptor; a narrative descriptor; an album creation date and time; an album creator identification; an album location; or a time and date range of captured media in the content album.

Example 7: The computer-implemented method of any of examples 1-6, wherein grouping the selection of the media files comprises: detecting the addition of new media files to the collection of media files; analyzing the new media files for the common set of user experiences; and adding the new media files containing the common set of user experiences to the customizable container.

Example 8: The computer-implemented method of any of examples 1-7, wherein sharing the customizable container comprises adding each of the target recipients as a viewer of the selected media files within a client application associated with the wearable media device.

Example 9: The computer-implemented method of any of examples 1-8, capturing new media files; adding the captured new media files to the customizable container; and sharing the captured new media files with the target recipients as the captured new media files are added to the customizable container.

Example 10: The computer-implemented method of any of examples 1-9, wherein generating a notification to the target recipients comprising an access link for accessing the selected media files from a social networking application associated with the wearable media device client application.

Example 11: A system comprising: at least one physical processor; physical memory comprising computer-executable instructions and one or more modules that, when executed by the physical processor, cause the physical processor to: detect, by a detection module, a collection of media files captured by a wearable media device; determine, by a determining module, a selection of the media files representing a common set of user experiences accumulated over a continuous period; group, by a container module, the selection of the media files into a customizable container; and share, by a sharing module, the customizable container with one or more target recipients for viewing within a secure application portal.

Example 12: The system of example 11, wherein the detection module detects the collection of media files by detecting content continually captured by the wearable media device.

Example 13: The system of example 11 or 12, wherein the determining module determines the selection of the media files by: generating at least one classifier describing one or common features in captured content represented in the media files; and identifying a set of the media files as the selection based on the classifier.

Example 14: The system of any of examples 11-13, wherein the determining module determines the selection of the media files by: analyzing, utilizing a machine learning algorithm, the media files to detect metadata describing one or more common features in captured content; and identifying a set of the media files as the selection based on the metadata.

Example 15: The system of any of examples 11-14, wherein the container module groups the selection of the media files by: storing the selection of media files as a content album in the customizable container; and adding metadata describing the content album.

Example 16: The system of any of examples, 11-15, wherein the metadata describing the content album comprises at least one of: an album title; an album descriptor; a narrative descriptor; an album creation date and time; an album creator identification; an album location; or a time and date range of captured media in the content album.

Example 17: The system of any of examples 11-16, wherein the container module groups the selection of the media files by: detecting the addition of new media files to the collection of media files; analyzing the new media files for the common set of user experiences; and adding the new media files containing the common set of user experiences to the customizable container.

Example 18: The system of any of examples 11-17, wherein the sharing module shares the customizable container by adding each of the target recipients as a viewer of the selected media files within a client application associated with the wearable media device.

Example 19: The system of any of examples 11-18, wherein the sharing module further shares the customizable container by: capturing new media files; adding the captured new media files to the customizable container; and sharing the captured new media files with the target recipients as the captured new media files are added to the customizable container.

Example 20: A non-transitory computer-readable medium comprising one or more computer-executable instructions that, when executed by at least one processor of a computing device, cause the computing device to: detect a collection of media files captured by a wearable media device; determine a selection of the media files representing a common set of user experiences accumulated over a continuous period; group the selection of the media files into a customizable container; and share the customizable container with one or more target recipients for viewing within a secure application portal.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 100 in FIG. 1) or that visually immerses a user in an artificial reality (such as, e.g., virtual-reality system Error! Reference source not found.00 in FIG. Error! Reference source not found). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 1, augmented-reality system 100 may include an eyewear device 102 with a frame 110 configured to hold a left display device 115(A) and a right display device 115(B) in front of a user's eyes. Display devices 115(A) and 115(B) may act together or independently to present an image or series of images to a user. While augmented-reality system 100 includes two displays, embodiments of this disclosure may be implemented in augmented-reality systems with a single NED or more than two NEDs.

In some embodiments, augmented-reality system 100 may include one or more sensors, such as sensor 140. Sensor 140 may generate measurement signals in response to motion of augmented-reality system 100 and may be located on substantially any portion of frame 110. Sensor 140 may represent one or more of a variety of different sensing mechanisms, such as a position sensor, an inertial measurement unit (IMU), a depth camera assembly, a structured light emitter and/or detector, or any combination thereof. In some embodiments, augmented-reality system 100 may or may not include sensor 140 or may include more than one sensor. In embodiments in which sensor 140 includes an IMU, the IMU may generate calibration data based on measurement signals from sensor 140. Examples of sensor 140 may include, without limitation, accelerometers, gyroscopes, magnetometers, other suitable types of sensors that detect motion, sensors used for error correction of the IMU, or some combination thereof.

In some examples, augmented-reality system 100 may also include a microphone array with a plurality of acoustic transducers 120(A)-120(J), referred to collectively as acoustic transducers 120. Acoustic transducers 120 may represent transducers that detect air pressure variations induced by sound waves. Each acoustic transducer 120 may be configured to detect sound and convert the detected sound into an electronic format (e.g., an analog or digital format). The microphone array in FIG. 1 may include, for example, ten acoustic transducers: 120(A) and 120(B), which may be designed to be placed inside a corresponding ear of the user, acoustic transducers 120(C), 120(D), 120(E), 120(F), 120(G), and 120(H), which may be positioned at various locations on frame 110, and/or acoustic transducers 120(1) and 120(J), which may be positioned on a corresponding neckband 105.

In some embodiments, one or more of acoustic transducers 120(A)-(J) may be used as output transducers (e.g., speakers). For example, acoustic transducers 120(A) and/or 120(B) may be earbuds or any other suitable type of headphone or speaker.

The configuration of acoustic transducers 120 of the microphone array may vary. While augmented-reality system 100 is shown in FIG. 1 as having ten acoustic transducers 120, the number of acoustic transducers 120 may be greater or less than ten. In some embodiments, using higher numbers of acoustic transducers 120 may increase the amount of audio information collected and/or the sensitivity and accuracy of the audio information. In contrast, using a lower number of acoustic transducers 120 may decrease the computing power required by an associated controller 150 to process the collected audio information. In addition, the position of each acoustic transducer 120 of the microphone array may vary. For example, the position of an acoustic transducer 120 may include a defined position on the user, a defined coordinate on frame 110, an orientation associated with each acoustic transducer 120, or some combination thereof.

Acoustic transducers 120(A) and 120(B) may be positioned on different parts of the user's ear, such as behind the pinna, behind the tragus, and/or within the auricle or fossa. Or, there may be additional acoustic transducers 120 on or surrounding the ear in addition to acoustic transducers 120 inside the ear canal. Having an acoustic transducer 120 positioned next to an ear canal of a user may enable the microphone array to collect information on how sounds arrive at the ear canal. By positioning at least two of acoustic transducers 120 on either side of a user's head (e.g., as binaural microphones), augmented-reality device 100 may simulate binaural hearing and capture a 3D stereo sound field around about a user's head. In some embodiments, acoustic transducers 120(A) and 120(B) may be connected to augmented-reality system 100 via a wired connection 130, and in other embodiments acoustic transducers 120(A) and 120(B) may be connected to augmented-reality system 100 via a wireless connection (e.g., a BLUETOOTH connection). In still other embodiments, acoustic transducers 120(A) and 120(B) may not be used at all in conjunction with augmented-reality system 100.

Acoustic transducers 120 on frame 110 may be positioned in a variety of different ways, including along the length of the temples, across the bridge, above or below display devices 115(A) and 115(B), or some combination thereof. Acoustic transducers 120 may also be oriented such that the microphone array is able to detect sounds in a wide range of directions surrounding the user wearing the augmented-reality system 100. In some embodiments, an optimization process may be performed during manufacturing of augmented-reality system 100 to determine relative positioning of each acoustic transducer 120 in the microphone array.

In some examples, augmented-reality system 100 may include or be connected to an external device (e.g., a paired device), such as neckband 105. Neckband 105 generally represents any type or form of paired device. Thus, the following discussion of neckband 105 may also apply to various other paired devices, such as charging cases, smart watches, smart phones, wrist bands, other wearable devices, hand-held controllers, tablet computers, laptop computers, other external compute devices, etc.

As shown, neckband 105 may be coupled to eyewear device 102 via one or more connectors. The connectors may be wired or wireless and may include electrical and/or non-electrical (e.g., structural) components. In some cases, eyewear device 102 and neckband 105 may operate independently without any wired or wireless connection between them. While FIG. 1 illustrates the components of eyewear device 102 and neckband 105 in example locations on eyewear device 102 and neckband 105, the components may be located elsewhere and/or distributed differently on eyewear device 102 and/or neckband 105. In some embodiments, the components of eyewear device 102 and neckband 105 may be located on one or more additional peripheral devices paired with eyewear device 102, neckband 105, or some combination thereof.

Pairing external devices, such as neckband 105, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 100 may be provided by a paired device or shared between a paired device and an eyewear device, thus reducing the weight, heat profile, and form factor of the eyewear device overall while still retaining desired functionality. For example, neckband 105 may allow components that would otherwise be included on an eyewear device to be included in neckband 105 since users may tolerate a heavier weight load on their shoulders than they would tolerate on their heads. Neckband 105 may also have a larger surface area over which to diffuse and disperse heat to the ambient environment. Thus, neckband 105 may allow for greater battery and computation capacity than might otherwise have been possible on a stand-alone eyewear device. Since weight carried in neckband 105 may be less invasive to a user than weight carried in eyewear device 102, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 105 may be communicatively coupled with eyewear device 102 and/or to other devices. These other devices may provide certain functions (e.g., tracking, localizing, depth mapping, processing, storage, etc.) to augmented-reality system 100. In the embodiment of FIG. 1, neckband 105 may include two acoustic transducers (e.g., 120(1) and 120(J)) that are part of the microphone array (or potentially form their own microphone subarray). Neckband 105 may also include a controller 125 and a power source 135.

Acoustic transducers 120(1) and 120(J) of neckband 105 may be configured to detect sound and convert the detected sound into an electronic format (analog or digital). In the embodiment of FIG. 1, acoustic transducers 120(1) and 120(J) may be positioned on neckband 105, thereby increasing the distance between the neckband acoustic transducers 120(1) and 120(J) and other acoustic transducers 120 positioned on eyewear device 102. In some cases, increasing the distance between acoustic transducers 120 of the microphone array may improve the accuracy of beamforming performed via the microphone array. For example, if a sound is detected by acoustic transducers 120(C) and 120(D) and the distance between acoustic transducers 120(C) and 120(D) is greater than, e.g., the distance between acoustic transducers 120(D) and 120(E), the determined source location of the detected sound may be more accurate than if the sound had been detected by acoustic transducers 120(D) and 120(E).

Controller 125 of neckband 105 may process information generated by the sensors on neckband 105 and/or augmented-reality system 100. For example, controller 125 may process information from the microphone array that describes sounds detected by the microphone array. For each detected sound, controller 125 may perform a direction-of-arrival (DOA) estimation to estimate a direction from which the detected sound arrived at the microphone array. As the microphone array detects sounds, controller 125 may populate an audio data set with the information. In embodiments in which augmented-reality system 100 includes an inertial measurement unit, controller 125 may compute all inertial and spatial calculations from the IMU located on eyewear device 102. A connector may convey information between augmented-reality system 100 and neckband 105 and between augmented-reality system 100 and controller 125. The information may be in the form of optical data, electrical data, wireless data, or any other transmittable data form. Moving the processing of information generated by augmented-reality system 100 to neckband 105 may reduce weight and heat in eyewear device 102, making it more comfortable to the user.

Power source 135 in neckband 105 may provide power to eyewear device 102 and/or to neckband 105. Power source 135 may include, without limitation, lithium ion batteries, lithium-polymer batteries, primary lithium batteries, alkaline batteries, or any other form of power storage. In some cases, power source 135 may be a wired power source. Including power source 135 on neckband 105 instead of on eyewear device 102 may help better distribute the weight and heat generated by power source 135.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1300 in FIG. 13, that mostly or completely covers a user's field of view. Virtual-reality system 1300 may include a front rigid body 1302 and a band 1304 shaped to fit around a user's head. Virtual-reality system 1300 may also include output audio transducers 1306(A) and 1306(B). Furthermore, while not shown in FIG. 13, front rigid body 1302 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 100 and/or virtual-reality system 1200 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 100 and/or virtual-reality system 1200 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 100 and/or virtual-reality system 1300 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.

1. A computer-implemented method comprising:
detecting, by one or more computing devices, a collection of media files captured in at least one of multiple simultaneous video feeds and multiple cameras by a wearable media device;
determining, by the one or more computing devices, a selection of the media files representing a common set of user experiences accumulated over a continuous period, the common set of user experiences comprising a media instance having a description of a first user experience captured by the wearable media device in the media files and at least one other media instance having a description of at least one other user experience captured by the wearable media device in the media files, wherein the description of the at least one other user experience includes an activity commonly associated with an activity in the description of the first user experience during the continuous period, wherein determining the selection of the media files comprises utilizing a machine learning algorithm to identify, from the media files, the description of the at least one other user experience including the activity commonly associated with the activity in the description of the first user experience during the continuous period, thereby reducing a time-consuming process associated with a manual identification of the common set of user experiences in the collection of media files captured in the at least one of the multiple simultaneous video feeds and the multiple cameras by the wearable media device;
grouping, by the one or more computing devices, the selection of the media files into a customizable container; and
sharing, by the one or more computing devices, the customizable container with one or more target recipients for viewing within a secure application portal.

2. The computer-implemented method of claim 1, wherein detecting the collection of media files comprises detecting content continually captured by the wearable media device.

3. The computer-implemented method of claim 1, wherein determining the selection of the media files comprises:
generating at least one classifier describing one or more common features in captured content represented in the media files; and
identifying a set of the media files as the selection based on the classifier.

4. (canceled)

5. The computer-implemented method of claim 1, wherein grouping the selection of the media files comprises:
storing the selection of media files as a content album in the customizable container; and
adding metadata describing the content album.

6. The computer-implemented method of claim 5, wherein adding metadata describing the content album comprises adding at least one of:
an album title;
an album descriptor;
a narrative descriptor;
an album creation date and time;
an album creator identification;
an album location; or
a time and date range of captured media in the content album.

7. The computer-implemented method of claim 1, wherein grouping the selection of the media files comprises:
detecting an addition of new media files to the collection of media files;
analyzing the new media files for the common set of user experiences; and
adding the new media files containing the common set of user experiences to the customizable container.

8. The computer-implemented method of claim 1, wherein sharing the customizable container comprises adding each of the target recipients as a viewer of the selected media files within a client application associated with the wearable media device.

9. The computer-implemented method of claim 8, further comprising:
capturing new media files;
adding the captured new media files to the customizable container; and
sharing the captured new media files with the one or more target recipients as the captured new media files are added to the customizable container.

10. The computer-implemented method of claim 8, further comprising generating a notification to the target recipients comprising an access link for accessing the selected media files from a social networking application associated with the wearable media device client application.

11. A system comprising:
at least one physical processor;
physical memory comprising computer-executable instructions and one or more modules that, when executed by the physical processor, cause the physical processor to:
detect, by a detection module, a collection of media files captured in at least one of multiple simultaneous video feeds and multiple cameras by a wearable media device;
determine, by a determining module, a selection of the media files representing a common set of user experiences accumulated over a continuous period, the common set of user experiences comprising a media instance having a description of a first user experience captured by the wearable media device in the media files and at least one other media instance having a description of at least one other user experience captured by the wearable media device in the media files, wherein the description of the at least one other user experience includes an activity commonly associated with an activity in the description of the first user experience during the continuous period, wherein determining the selection of the media files comprises utilizing a machine learning algorithm to identify, from the media files, the description of the at least one other user experience including the activity commonly associated with the activity in the description of the first user experience during the continuous period, thereby reducing a time-consuming process associated with a manual identification of the common set of user experiences in the collection of media files captured in the at least one of the multiple simultaneous video feeds and the multiple cameras by the wearable media device;
group, by a container module, the selection of the media files into a customizable container; and
share, by a sharing module, the customizable container with one or more target recipients for viewing within a secure application portal.

12. The system of claim 11, wherein the detection module detects the collection of media files by detecting content continually captured by the wearable media device.

13. The system of claim 11, wherein the determining module determines the selection of the media files by:
generating at least one classifier describing one or more common features in captured content represented in the media files; and
identifying a set of the media files as the selection based on the classifier.

14. (canceled)

15. The system of claim 11, wherein the container module groups the selection of the media files by:
storing the selection of media files as a content album in the customizable container; and
adding metadata describing the content album.

16. The system of claim 15, wherein the metadata describing the content album comprises at least one of:
an album title;
an album descriptor;
a narrative descriptor;
an album creation date and time;
an album creator identification;
an album location; or
a time and date range of captured media in the content album.

17. The system of claim 11, wherein the container module groups the selection of the media files by:
detecting an addition of new media files to the collection of media files;
analyzing the new media files for the common set of user experiences; and
adding the new media files containing the common set of user experiences to the customizable container.

18. The system of claim 11, wherein the sharing module shares the customizable container by adding each of the target recipients as a viewer of the selected media files within a client application associated with the wearable media device.

19. The system of claim 18, wherein the sharing module further shares the customizable container by:
capturing new media files;
adding the captured new media files to the customizable container; and
sharing the captured new media files with the one or more target recipients as the captured new media files are added to the customizable container.

20. A non-transitory computer-readable medium comprising one or more computer-executable instructions that, when executed by at least one processor of a computing device, cause the computing device to:
detect a collection of media files captured in at least one of multiple simultaneous video feeds and multiple cameras by a wearable media device;
determine a selection of the media files representing a common set of user experiences accumulated over a continuous period, the common set of user experiences comprising a media instance having a description of a first user experience captured by the wearable media device in the media files and at least one other media instance having a description of at least one other user experience captured by the wearable media device in the media files, wherein the description of the at least one other user experience includes an activity commonly associated with an activity in the description of the first user experience during the continuous period, wherein determining the selection of the media files comprises utilizing a machine learning algorithm to identify, from the media files, the description of the at least one other user experience including the activity commonly associated with the activity in the description of the first user experience during the continuous period, thereby reducing a time-consuming process associated with a manual identification of the common set of user experiences in the collection of media files captured in the at least one of the multiple simultaneous video feeds and the multiple cameras by the wearable media device;
group the selection of the media files into a customizable container; and
share the customizable container with one or more target recipients for viewing within a secure application portal.

21. The computer-implemented method of claim 1, wherein the continuous period comprises a period that is less than twenty-four hours.

22. The system of claim 11, wherein the continuous period comprises a period that is less than twenty-four hours.
